(19) United States
(12) Patent Application Publication
(10) Pub. No.: US 2017/0003466 A1
(43) Pub. Date: Jan. 5, 2017

(54) OPTICAL FIBER CONDUCTOR

(71) Applicant: Google Inc., Mountain View, CA (US)

(72) Inventors: Chris Smith, Palo Alto, CA (US); Peter C. Chane, Menlo Park, CA (US)

(21) Appl. No.: 14/268,114

(22) Filed: May 2, 2014

(51) Int. Cl. G02B 6/44

(52) U.S. Cl. CPC G02B 6/4457; G02B 6/4439

(57) ABSTRACT

An apparatus includes a length of flexible tape defined between a first end of the tape and a second end of the tape, the flexible tape including an adhesive surface that extends lengthwise between the first and second ends of the tape; and a fiber optic strand embedded within a volume of the flexible tape and extending between the first and second ends of the tape.

### TECHNICAL FIELD

This disclosure relates to optical fibers and, more particularly, to surface-mountable optical fibers or cables.

### BACKGROUND

Optical fibers or cables are attractive for use in networks for telecommunications, televisions, and internet connections. For example, voice, data, and video services can be provided to customers through optical fibers deployed in customers' premises. In some cases, optical fibers are encased in protective jackets and routed through conduits and cable trays. In some cases, optical fibers are enclosed in a duct and later adhered to a wall with adhesive. In some cases, optical fibers are routed in a customer premises and simultaneously adhered on a wall of the premises by applying adhesive with glue and a caulk gun.

### SUMMARY

In a general implementation, an apparatus includes a length of flexible tape defined between a first end of the tape and a second end of the tape, the flexible tape including an adhesive surface that extends lengthwise between the first and second ends of the tape; and a fiber optic strand embedded within a volume of the flexible tape and extending between the first and second ends of the tape.

A first aspect combinable with the general implementation further includes a first fiber optic connector coupled to a first end of the fiber optic strand.

A second aspect combinable with any of the previous aspects further includes a second fiber optic connector coupled to a second end of the fiber optic strand.

In a third aspect combinable with any of the previous aspects, at least one of the first or second fiber optic connectors includes an SC/APC, SC/UPC, LC/UPC, or LC/APC connector.

A fourth aspect combinable with any of the previous aspects further includes a removable film attached to the adhesive surface.

In a fifth aspect combinable with any of the previous aspects, the flexible tape is clear or opaque.

In a sixth aspect combinable with any of the previous aspects, the fiber optic strand is clear or opaque.

In a seventh aspect combinable with any of the previous aspects, the fiber optic strand is about 900 μm in diameter.

In an eighth aspect combinable with any of the previous aspects, the flexible tape includes a polyfilm or a polyurethane film.

In another general implementation, a fiber optic network interface system includes a housing that includes an exterior surface mountable to a support structure, and an inner volume defined by the housing; a reel mountable in the housing and rotatable about an axis; and a length of flexible tape wound about the reel. The flexible tape includes an adhesive surface that extends lengthwise between a first end and a second end of the tape; and a fiber optic strand embedded within the flexible tape and extending between the first and second ends of the tape.

A first aspect combinable with the general implementation further includes a fiber optic connector coupled to the fiber optic strand and moveable through an opening in the housing.

In a second aspect combinable with any of the previous aspects, the fiber optic connector includes an SC/APC, SC/UPC, LC/UPC, or LC/APC connector.

In a third aspect combinable with any of the previous aspects, the fiber optic connector is coupled to the fiber optic strand at the first end of the tape and configured to be coupled to an optical network terminal.

In a fourth aspect combinable with any of the previous aspects, the tape further includes a second fiber optic connector coupled to the fiber optic strand at the second end of the tape.

A fifth aspect combinable with any of the previous aspects further includes an adapter mounted inside the reel and coupled to the second fiber optic connector.

In a sixth aspect combinable with any of the previous aspects, the system further includes a second adapter mounted in the housing, and the second adapter includes a first terminal coupled to the adapter in the reel and a second terminal coupled to a source of incoming optical signals.

In a seventh aspect combinable with any of the previous aspects, at least one of the flexible tape or the fiber optic strand is clear or opaque.

In an eighth aspect combinable with any of the previous aspects, the length of flexible tape further includes a removable film attached to the adhesive surface.

In a ninth aspect combinable with any of the previous aspects, the flexible tape is between about 7 mm and about 25 mm wide, and between about 1.5 mm and about 2.5 mm thick, and the fiber optic strand is about 900 μm in diameter.

In a tenth aspect combinable with any of the previous aspects, the fiber optic strand includes a plurality of fiber optic strands.

In another general implementation, a method of manufacture of a fiber optic conductor, includes embedding a fiber optic strand within a length of flexible tape; applying an adhesive to a surface of the length of flexible tape; and coupling a fiber optic connector to an end of the fiber optic strand that extends from the length of flexible tape.

In a first aspect combinable with the general implementation, embedding a fiber optic strand within a length of flexible tape includes embedding the fiber optic strand in an approximate cross-sectional center of the length of flexible tape.

A second aspect combinable with any of the previous aspects further includes applying a removable film to the adhesive surface.

A third aspect combinable with any of the previous aspects further includes installing a protective boot over a portion of the fiber optic strand that extends from the length of the flexible tape between the fiber optic connector and an end of the flexible tape.

In a fourth aspect combinable with any of the previous aspects, the fiber optic strand is about 900 μm in diameter.

In a fifth aspect combinable with any of the previous aspects, the flexible tape is between about 7 mm and about 25 mm wide, and between about 1.5 mm and about 2.5 mm thick.

Various implementations of a fiber tape may include one or more of the following features. For example, the fiber tape enables easy installation and allows a customer to install a network connection system in the customer's premises on his/her own, which dramatically saves time and money for a service provider and/or the customer. The fiber tape allows the customer to decide where the fiber tape will be routed and placed in the customer's premises, and provides a much better customer experience for the customer. Moreover, using the fiber tape eliminates splicing of fiber drops and need for drills and hammers, and minimizes slack storage space.

These general and specific aspects may be implemented using a device, system, method, or any combinations of devices, systems, or methods. The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1A illustrates an example implementation of a fiber tape.

FIG. 1B illustrates a side view of the fiber tape of FIG. 1A.

FIG. 2A illustrates an example implementation of a reel wound with a fiber tape.

FIG. 2B illustrates a side view of the reel of FIG. 2A.

FIG. 2C illustrates a cross-sectional view of the reel of FIG. 2B.

FIG. 3A illustrates an example implementation of a fiber optic network interface system.

FIGS. 3B-3C illustrate various views of a housing of the fiber optic network interface system of FIG. 3A.

FIG. 4A illustrates a network system using a fiber tape for network connections at a premises.

FIG. 4B illustrates arrangment of the fiber tape of FIG. 4A at corners of the premises.

### DETAILED DESCRIPTION

The present disclosure describes a fiber tape including an optical fiber embedded within an adhesive tape. The fiber tape may be used to provide a surface-mountable optical fiber for network connections at customer premises, e.g., single family units (SFUs), multi dwelling units (MDUs), or small and medium-sized businesses (SMBs), as well as other premises. A customer can install a network system by connecting a network interface system to an optical network terminal with the fiber tape. The customer can roll off a desired length of the fiber tape from the network interface system, adhere the fiber tape to a structural surface, e.g., a wall or ceiling, at the customer premises in a desired path, and connect the fiber tape to the optical network terminal.

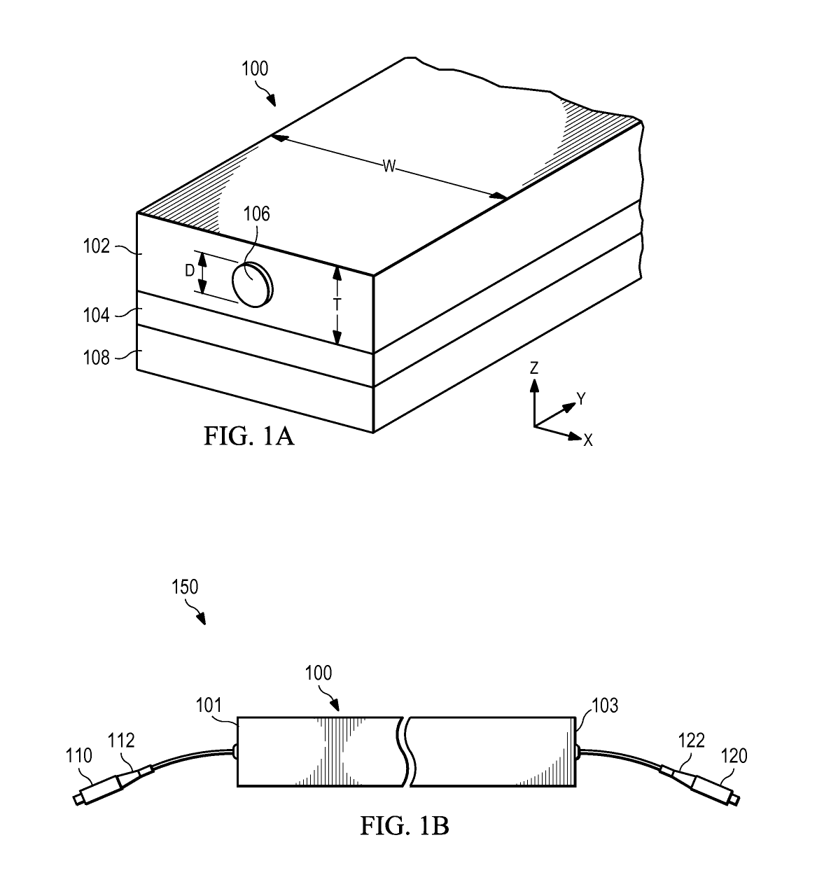

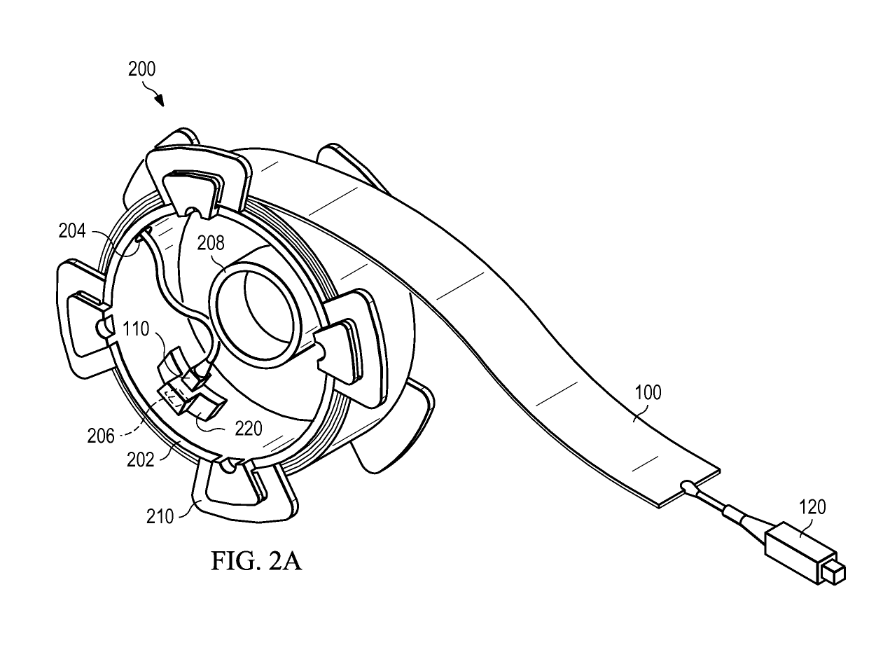

FIGS. 1A and 1B illustrate an example implementation of a fiber tape 100. The fiber tape 100 includes a tape 102 with a length defined between a first end 101 and a second end 103 of the tape 102. The tape 102 may be a flexible strip. The tape 102 may include a polyester film or a polyurethane film. The tape 102 can be transparent or opaque. In some examples, the tape 102 is made in various colors and designed to match existing structural surfaces of a customer's premises.

The tape 102 includes a bottom side of the tape 102 that extends lengthwise between the first end 101 and the second end 103. The bottom side can be coated with an adhesive 104. An upper side of the tape 102 may include a surface without adhesive. The adhesive 104 is designed to be compatible with one or more different types of surfaces, including painted smooth surfaces (e.g., flat latex, semi-gloss latex, glossy latex, or semi-gloss Alkyd), painted textured surfaces (e.g., light stucco or cement block), or wallpapered surfaces (e.g., plain paper, vinyl coated, vinyl, or polyolefin woven). The adhesive 104 can be made of any suitable material, e.g., rubber based adhesive. The adhesive 104 may be transparent or opaque in some implementations.

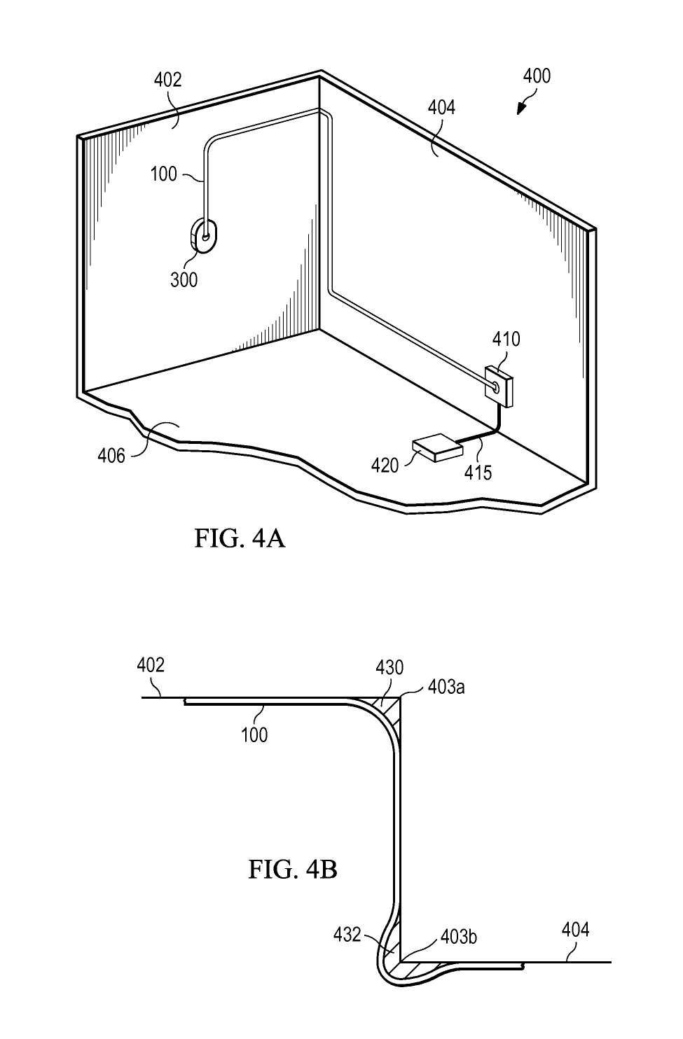

In some implementations, the tape 102 may include one or more surfaces that are paintable and/or prepared to accept a coat of paint. For instance, in some aspects, a top surface of the tape 102 (e.g., the surface of the tape 102 opposite the adhesive 104) may be paintable with any color and/or type of paint before or after installation (e.g., as described with reference to FIG. 4A. In some aspects, for instance, the tope surface may be prepared to accept a latex or oil-based paint or lacquer without peeling of the pain or lacquer for an extended period of time. Thus, in some aspects, for example, once the tape 102 is installed onto one or more surfaces of a structure, the top surface of the tape 102 may be painted (e.g., the same or similar color as the structure), to allow the tape 102 to better blend in to the surrounding environment.

In some implementations, the adhesive 104 is designed for the tape 102 to be peeled off without damaging a surface, but be still strong enough for the tape 102 to be adhered on the surface without dropping. In some implementations, the adhesive 104 is engineered for long term performance. Removal of the fiber tape 100 from a surface may cause damage to the surface. In some implementations, the adhesive 104 is engineered to be bonded to a surface with increased adhesive strength or portions of adhesive over time. In a particular example, at room temperature 50% of the adhesive 104 is bonded to the surface within 30 minutes of installation, 90% after 24 hours, and 100% after 72 hours. In some cases, the tape 102 is a pressure-sensitive tape, and the adhesive 104 can be stabilized on a surface with pressure during installation of the fiber tape 100. A grade of the adhesive 104 may be selected according to a degree of permanency desired for installation of the fiber tape 100. The adhesive 104 may allow immediate repositioning of the fiber tape 100 on surfaces during installation. In some implementations, the adhesive 104 is designed to work under a wide range of temperature and/or humidity, e.g., in indoor environments with temperatures ranging from 0° C. to 40° C. and 30-50% relative humidity.

In some implementations, the fiber tape 100 includes a temporary, easily removable film 108, e.g., cellophane, attached to the adhesive 104. The film 108 can cover the adhesive 104 until the fiber tape 100 is ready for installation. The film 108 permits the fiber tape 100 to be rolled for storage and handled prior to installation.

The fiber tape 100 includes a fiber optic strand 106 embedded within a volume of the tape 102 and extending between the first end 101 and the second end 103 of the tape 102. The fiber optic strand 106 may be transparent or opaque. The fiber optic strand 106 is embedded within the tape 102, e.g., at an approximate cross-sectional center of the tape 102. The fiber optic strand 106 has a diameter D, which may be smaller than a thickness, T, and a width, W, of the tape 102. The illustrated fiber optic strand 106 includes a core sequentially surrounded by a cladding layer, a coating layer, and/or a tight buffered layer. In some aspects, the fiber optic strand 106 may not include one, some, or all of the cladding layer, the coating layer, and the tight buffered layer.

Although not to scale, in the particular example implementation shown in FIG. 1A, the diameter, D, of the fiber optic strand 106 is about 900 micrometers (um). The thickness, T, of the tape 102 is between about 1.5 millimeters (mm) and about 2.5 mm. The width, W, of the tape 102 is between about 7 mm and about 25 mm (and in some examples between about 7 mm and about 10 mm wide). In some implementations, one or more fiber optic strands 106 are embedded within the tape 102. The one or more fiber optic strands 106 can be positioned in parallel along the width, W, of the tape 102.

The fiber optic strand 106 can be engineered to transmit light over a long distance with substantially low loss. In some examples, the fiber optic strand 106 includes a single-mode fiber. In a particular example, the single-mode fiber has a propagation loss of less than 0.05 decibel (dB) per kilometer at wavelengths of 1310 nm, 1550 nm, and/or 1625 nm. In some examples, the fiber optic strand 106 includes one or more single-mode fibers or a multi-mode fiber.

The fiber optic strand 106 can be engineered to have a large pull strength such that the fiber tape 100 can endure large pull force. The fiber optic strand 106 may have a minimum pull strength of 15 pounds (lbs) with less than 0.05% elongation. In a particular example, the fiber optic strand 106 has a pull strength of about 15 to 20 lbs. In some examples, the fiber optic strand 106 includes a single-mode fiber and one or more protective strands adjacent to the single-mode fiber. The protective strands can be flexible and mechanically more durable than the single-mode fibers. In some examples, one or more protective strands are positioned adjacent to the fiber optic strand 106 within the tape 102.

The fiber optic strand 106 can be engineered to work under a wide range of temperatures. In some examples, the fiber optic strand 106 works in cold or warm temperatures, e.g., from −40° C. to +85° C.

The fiber optic strand 106 can be engineered to have substantially low bending loss, e.g., at corners or turns. In some examples, the fiber optic strand 106 includes a bend-insensitive single mode fiber that meets standard ITU-T G.657.A.3. For example, the fiber optic strand 106 can provide a macrobending loss of less than 0.10 dB, e.g., 0.06 dB, at 1550 nm over a full turn with a bend radius of 5 mm or 0.20 dB at 1550 nm loss over a full turn with a bend radius of 2.5 mm. In some examples, to avoid bending losses and to prevent breakage, bend managers, e.g., bend limiters or curvature-limiting devices, can be utilized at points where the fiber tape 100 is routed around a corner, as described with further details in FIG. 4B.

The fiber tape 100 can be utilized in an optical interconnection system and be connected to other optical cables and/or to optical apparatus with fiber optic connectors. As illustrated in FIG. 1B, the fiber tape 100 can include a fiber optic connector 110 coupled to an end of the fiber optic strand 106 at the first end 101 of the fiber tape 100. In some examples, a protective boot 112 is used to protect a connection between the fiber optic strand 106 and the fiber optic connector 110. The fiber tape 100 can further include another fiber optic connector 120 coupled to the other end of the fiber optic strand 106 at the second end 103 of the fiber tape 100. Another protective boot 122 can be used to protect a connection between the fiber optic strand 106 and the fiber optic connector 120. The fiber optic connector 110 or 120 can be an SC or LC connector, more particularly, an SC/APC, SC/UPC, LC/APC, or LC/UPC connector. In some examples, the fiber optic connector 110 or 120 is sized to pull through a hole, e.g., with a diameter of ¾ inch.

In some aspects, another protective sheath, such as a protective boot, may be installed at each end of the fiber optic strand 106 at a location just external to the fiber tape 100. The protective sheath may help protect the strand 106 from damage due to, for instance, bending of the strand 106 at the locations where it extends from the tape 100. For instance, the protective sheath may ensure or help ensure that a maximum bend radius of the strand 106 is not exceeded during handling, usage, and/or installation.

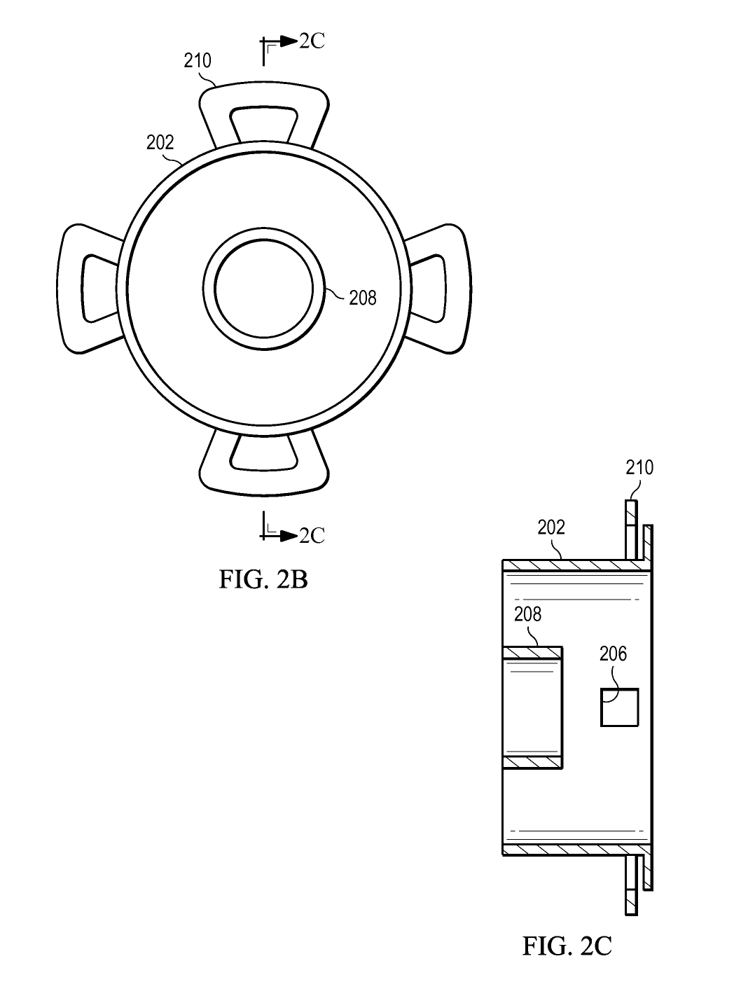

FIGS. 2A-2C illustrate an example implementation of a reel 200 on which a length of a fiber tape, e.g., the fiber tape 100 of FIGS. 1A-1B, is wound. The reel 200 may include a body 202 to contain the length of the fiber tape 100. The reel 200 can contain different lengths of fiber tapes. In a particular example, the illustrated reel 200 can store up to 50 meters of fiber tape 100. The body 202 includes front and bottom sides that define a width therebetween. The width of the body 202 may be sized to be slightly larger than the width of the fiber tape 100, e.g., the width, W, of the fiber tape 100. The body 202 may be a cylindrical body and include one or more flanges 210, e.g., equally distributed, along a circumference of the front end and/or the bottom end of the body 202, to keep the fiber tape 100 on the body 202.

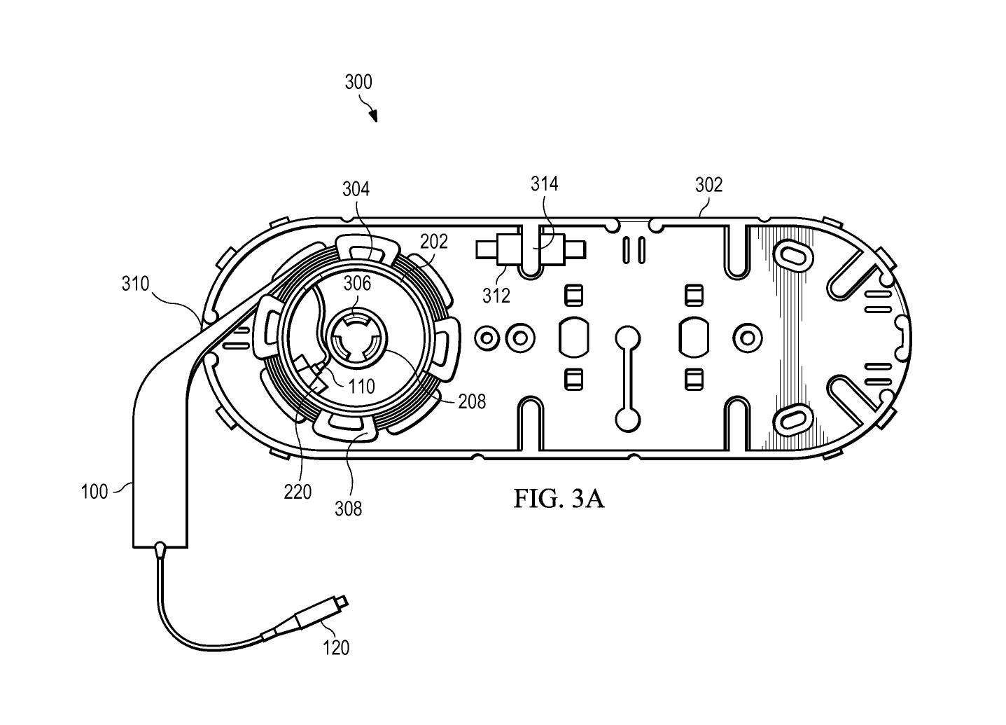

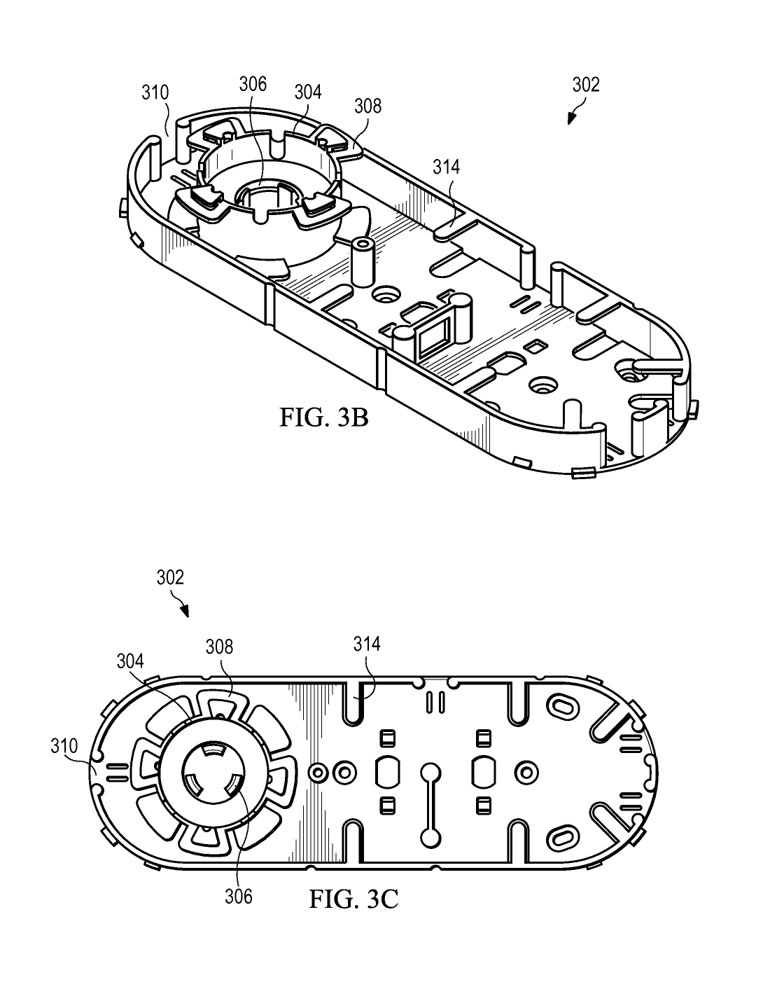

The reel 200 is designed to be rotatable about an axis so that the fiber tape 100 unwinds from the reel 200 while the fiber tape 100 is being routed over a desired span on a structural surface at a customer's premises. The reel 200 can be designed to be mounted on a network interface system, e.g., a fiber optic network interface system 300 of FIGS. 3A-3C as discussed in further detail below. The reel 200 may be constructed and arranged for easy mounting in the network interface system, and for quick removal when the wound fiber tape is exhausted or when another reel containing a different type of fiber tape is desired.

In some examples, the body 202 is a hollow body and includes a ring 208 inside the body 202. The ring 208 may extend from the bottom end towards the front end of the body 202 along an inner wall of the body 202. The ring 208 may have a thickness smaller than the width between the bottom and front ends. The ring 208 can be sized, e.g., by sizing an inner diameter of the ring 208, to fit with a cradle of the network interface system, such that the reel 202 can be mounted on the network interface system and rotatable about an axis. A central axis of the ring 208 may be substantially same as the axis. The body 202 may be sized, e.g., by sizing an outer diameter of the body, to fit into the network interface system.

In some implementations, the reel 200 contains a pair of termination units or boxes, each of which is detachably fastened to a corresponding side wall or flange of the body 202. The pair of termination units or boxes can be sized to fit into a network interface system such that the reel 200 can be mounted on the network interface system and rotatable about an axis.

Opposite ends of the fiber tape 100 on the reel 200 may be un-terminated, or terminated at one or both ends with specified connectors. In some examples, the fiber tape 100 includes a first fiber optic connector 110 and a second fiber optic connector 120 on opposed ends of the fiber tape 100. The first fiber connector 110 can be pulled inside of the body 202, e.g., through a hole or recess 204. The reel 200 may include a fiber connector adapter 220 mounted on an inner wall of the body 202, e.g., at a hole 206 of the inner wall. A position of the hole 206 can be configured such that the fiber connector adapter 220 is kept a distance away from the ring 208.

The illustrated fiber connector adapter 220 includes a terminal mating with the first fiber optic connector 110 at the end of the fiber tape 100. The fiber connector adapter 220 may include another terminal that mates with another fiber optic connector that can connect to a source of incoming optical signals, e.g., through a fiber optic network interface system, as discussed in further details in FIG. 3A. The second fiber connector 120 may be placed freely on an outer surface of the reel 200 such that the fiber tape 100 can be freely and smoothly unwound from the reel 200 and extend towards an optical network terminal inside a customer's premises.

FIG. 3A illustrates an example implementation of a fiber optic network interface system 300. The network interface system 300 includes a housing 302 and a reel, e.g., the reel 200 of FIGS. 2A-2C, wound with a length of a fiber tape, e.g., the fiber tape 100 of FIGS. 1A-2A. FIGS. 3B-3C illustrate various views of the housing 302 of FIG. 3A. The housing 302 may include an exterior surface mountable to a support structure, e.g., a wall of a customer's premises, and an inner volume defined by the housing. The housing 302 can be mounted to the support structure by adhesive or fasteners.

The housing 302 includes a holding assembly for holding the reel 200 in the housing 302 such that the reel 200 is mounted in the housing 302 and rotatable about an axis. The reel 200 can be detachable from the housing 302. The holding assembly can include a holding body 304 and a cradle 306. The cradle 306 is configured to hold the ring 208 of the reel 200. The cradle 306 may be sized to have an outer diameter slightly smaller than the inner diameter of the ring 208 and a height close to the height of the ring 208. The holding body 304 may be configured to hold the body 202 of the reel 200. The holding body 304 may be a hollow body and have an inner diameter slightly larger than the outer diameter of the body 202 and a height close to the width of the body 202. In some cases, the holding body 304 includes one or more flanges 308 configured to support the flanges 210 of the reel 200.

The fiber tape 100 on the reel 200 can be unwound from the reel 200 towards outside of the housing 302 through an opening 310. The opening 310 may be sized to allow the optical connector 120 and the fiber tape 100 to go through. The fiber optic connector 110 of the fiber tape 100 is connected to a first terminal of the fiber connector adapter 220 inside the reel 200. The fiber connector adapter 220 may include a second terminal coupled to another fiber connector adapter 312, e.g., by using an optical cable having two fiber optic connectors coupled to the adapter 220 and the adapter 312, respectively. The adapter 312 can include two terminals, one for connecting to the adapter 220 and another for connecting to a source of incoming optical signals from outside of a customer's premises. The housing 302 can include a holder 314 to mount the adapter 312 in position.

FIG. 4A illustrates a network system 400 using a fiber tape for network connections at a customer's premises. The network system 400 includes a fiber optic network interface system, e.g., the fiber optic network interface system 300 of FIGS. 3A-3C, an optical network terminal 410, and a network device 420. Components of the network system 400 and/or instructions for installation of the network system can be provided by a service provider to the customer in a self-installation kit.

The optical network terminal 410 is configured to convert optical signals, e.g., gigabit symmetric fiber optical signals, to Ethernet signals, e.g., gigabit Ethernet signal. The network device 420 can serve as a router or a gateway device in the premises, providing voice, video, and data services for the premises networks. A plurality of devices can be wired to the network device 420 using Ethernet cables. A customer can connect computers, televisions, telephone, and other devices to the network device 420 using the Ethernet cables or wireless networks the network device 420 provides. In a particular example, the fiber optic network interface system 300 includes a network interface unit (NIU) from Google Fiber, the optical network terminal 410 includes a Fiber Jack from Google Fiber, and the router 420 includes a network box from Google Fiber.

As described above, the network interface system 300 can be connected to a source of incoming optical signals from outside of the customer's premises. For example, the source of the incoming optical signals is received at an adapter that is mounted on a wall. The customer can use an optical cable including two fiber optic connectors to connect the adapter to the adapter 312 in the network interface system 300. The optical signals can be transmitted from the network interface system 300, by using the fiber tape 100, to the optical network terminal 410, e.g., by connecting the second fiber optic connector 120 of the fiber tape 100 to a fiber optic connector of the optical network terminal 410. The optical network terminal 410 further converts the optical signals to Ethernet signals and transmits the Ethernet signals to the network device 420, by an Ethernet cable 415.

The customer's premises may include a wall 402, a wall 404, and a floor 406. In some cases, the network interface system 300 is mounted on the wall 402 at a first location. The network device 420 is placed on the floor 406 and connected to the optical network terminal 410 that is mounted on the wall 404 at a second location. The fiber tape 100 unwounded off a reel in the network interface system 300 may be routed from the first location on the wall 402 to the second location on the wall 404 along a path. The fiber tape 100 allows the customer to route the fiber tape 100 along any desired path. For example, as illustrated in FIG. 4A, the fiber tape 100 is first routed vertically up and horizontally from the wall 402 to the wall 404 around a first corner 403a, and then vertically down, around a second corner 403b, and horizontally to the optical network terminal 410.

During installation, the customer can roll off the fiber tape 100 from the network interface system 300 and adhere the fiber tape 100 to a wall surface, e.g., by applying pressure on the fiber tape 100 against the wall surface. In some implementations, additional tapes or fasteners can be intermittently pasted on the fiber tape 100 to further stabilize the fiber tape 100 on the wall surface.

When making a change for the routing direction, e.g., making a turn, the customer may allow redundancy of the fiber tape 100 at the turn to reduce bending loss or avoid breakage. FIG. 4B illustrates arrangment of the fiber tape of FIG. 4A at corners of the premises. When the fiber tape 100 is routed around right angle corners, e.g., the first corner 403a and the second corner 403b, bend managers may be used. A first bend manager 430 is used when the fiber tape 100 is routed inside of a right-angle corner, e.g., the first corner 403a. A second bend manager 432 is used when the fiber tape 100 is routed outside of a right-angle corner, e.g., the second corner 403b. The bend managers may include an adhesive surface for easy press on wall surfaces.

After the fiber tape 100 is routed close to the optical network terminal 410, the customer can connect the second fiber optic connector 120 of the fiber tape 100 to a fiber optic connector of the optical network terminal 410. The customer can then connect the optical network terminal 410 to the network device 420 by using the Ethernet cable 415.

The present disclosure also describes a method for fabricating a fiber tape, e.g., the fiber tape 100 of FIGS. 1A-1B, as disclosed above. The fiber tape may be fabricated and assembled in a factory environment. Fabricating the fiber tape may include embedding a fiber optic strand, e.g., the fiber optic strand 106 of FIG. 1A, within a length of a flexible tape, e.g., the tape 102 of FIG. 1A, and applying an adhesive, e.g., the adhesive 104 of FIG. 1A, to a surface of the length of flexible tape.

The fiber optic strand can be embedded in the flexible tape by using a sandwich technique: two half-thickness tapes are first introduced, then the fiber optic strand is placed between the two half-thickness tapes, and finally the two half-thickness tapes and the fiber optic strand are assembled under high pressure and temperature. In some examples, the fiber optic strand is embedded in an approximate cross-sectional center of the flexible tape. After applying the adhesive on the surface of the flexible tape, a removable film can be applied to the adhesive surface of the flexible tape along the length of the flexible tape.

In some implementations, a fiber optic connector can be coupled to an end of the fiber optic strand that extends from the length of flexible tape. A protective boot can be installed over a portion of the fiber optic strand that extends from the length of the flexible tape between the fiber optic connector and the end of the flexible tape. In some implementations, a second fiber optic connector can be coupled to an opposite end of the fiber optic strand, and a second protective boot can be installed over a second portion of the fiber optic strands that extends from the length of the flexible tape between the second fiber optic connector and the opposite end of the flexible tape.

A number of examples have been described. Nevertheless, it will be understood that various modifications may be made. For example, a fiber tape can be terminated with an optical element, e.g., a graded index lens, for optical connections. A fiber tape can include a sensing element, e.g., an optical grating, and be used as a fiber sensor. Accordingly, other examples are within the scope of the following claims.

1. An apparatus, comprising:
a length of flexible tape defined between a first end of the tape and a second end of the tape, the flexible tape comprising an adhesive surface that extends lengthwise between the first and second ends of the tape; and
a fiber optic strand embedded within a volume of the flexible tape and extending between the first and second ends of the tape, wherein the fiber optic strand has a diameter of about 900 micrometers (μm) and a pull strength of between 15 and 20 pounds.

2. The apparatus of claim 1, further comprising a first fiber optic connector coupled to a first end of the fiber optic strand.

3. The apparatus of claim 2, further comprising a second fiber optic connector coupled to a second end of the fiber optic strand.

4. The apparatus of claim 3, wherein at least one of the first or second fiber optic connectors comprises an SC/APC, SC/UPC, LC/UPC, or LC/APC connector.

5. The apparatus of claim 1, further comprising a removable film attached to the adhesive surface.

6. The apparatus of claim 1, wherein the flexible tape is clear or opaque.

7. The apparatus of claim 6, wherein the fiber optic strand is clear or opaque.

8. (canceled)

9. The apparatus of claim 1, wherein the flexible tape comprises a polyfilm or a polyurethane film.

10-20. (canceled)

21. A method of manufacture of a fiber optic conductor on a reel, comprising:
embedding a fiber optic strand within a length of flexible tape, the fiber optic strand having a diameter of about 900 μm and a pull strength of between 15 and 20 pounds;
applying an adhesive to a surface of the length of flexible tape; and
coupling a fiber optic connector to an end of the fiber optic strand that extends from the length of flexible tape.

22. The method of claim 21, wherein embedding a fiber optic strand within a length of flexible tape comprises embedding the fiber optic strand in an approximate cross-sectional center of the length of flexible tape.

23. The method of claim 21, further comprising applying a removable film to the adhesive surface.

24. The method of claim 21, further comprising installing a protective boot over a portion of the fiber optic strand that extends from the length of the flexible tape between the fiber optic connector and an end of the flexible tape.

25. (canceled)

26. The method of claim 21, wherein the flexible tape is between about 7 mm and about 25 mm wide, and between about 1.5 mm and about 2.5 mm thick.

27. The apparatus of claim 2, further comprising:
a reel rotatable about an axis, the first fiber optic connector moveable through an opening in the reel; and
an adapter mounted on an inner wall of the reel and connected to the first fiber optic connector inside the reel.

28-29. (canceled)

30. The method of claim 21, further comprising:
pulling the fiber optic connector through an opening of the reel;
connecting the fiber optic connector to an adapter mounted on an inner wall of the reel; and
wrapping the flexible tape on the reel about an axis.
